(19) United States
(12) Patent Application Publication
(10) Pub. No.: US 2004/0227850 A1
(43) Pub. Date: Nov. 18, 2004

(54) Digital camera for use with mobile phone

(76) Inventor: Tsung-Wei Chiang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/847,751

(22) Filed: May 17, 2004

(30) Foreign Application Priority Data
May 16, 2003 (TW) 92209066

(51) Int. Cl. H04N 5/225; G03B 39/00

(52) U.S. Cl. 348/375; 348/373; 348/372

(57) ABSTRACT

A digital camera (10) has a housing, a lens (30) disposed in the housing (20), and a charging unit (40) rotatably attached to the housing. The housing defines a receiving space (21) at a first end thereof. Two slots (22) are defined at a first main surface of the housing. The slots are in communication with the receiving space. The charging unit has a rotating member (41), and a pair of parallel conductive pins (42) extending outwardly from the rotating member. The charging unit is rotatably received in the receiving space of the housing.

### BACKGROUND OF THE INVENTION

1. Field of the Invention

The present invention relates to a digital camera, and particularly to a digital camera for using with a portable electronic device such as a mobile phone.

2. Description of Related Art

With the continued development of communications and multimedia technology, digital cameras are now in widespread use in many countries around the world. In addition, portable electronic devices such as mobile phones and personal digital assistants (PDAs) are developing into high quality, multi-functional apparatuses. The combination of a digital camera with a portable electronic device has become an important area of development of mobile multimedia technology. There are two kinds of digital cameras available for use with a portable electronic device: a built-in type digital camera, and a plug-in type digital camera.

The Ericsson MCA series digital camera, for use with the Ericsson T68 mobile phone, is a typical plug-in type digital camera. The MCA series digital camera is connected with the mobile phone by a connector disposed at a bottom portion thereof. However, the digital camera is powered by a battery of the mobile phone via the connector. Taking pictures and performing other actions using the digital camera consumes a considerable amount of electrical power of the battery, which shortens the usage time of the battery and increases the frequency of re-charging.

The Siemens IQP-500 digital camera, for use with the Siemens S57 mobile phone, is another typical plug-in type digital camera. The IQP-500 digital camera is connected with the mobile phone by a connector disposed at a side portion thereof. However, the IQP-500 digital camera is also powered by a battery of the mobile phone via the connector. Furthermore, the IQP-500 digital camera is equipped with a flash module, which consumes a huge amount of electrical power of the battery. Therefore, the IQP-500 digital camera dramatically shortens the usage time of the battery, which can lead to inconvenience for the mobile phone user.

An improved digital camera that overcomes the above-described problems is desired.

### SUMMARY OF THE INVENTION

Accordingly, an object of the present invention is to provide a digital camera which is compact and rechargeable.

In order to achieve the object set forth, a digital camera in accordance with the present invention comprises a housing, a lens disposed in the housing, and a charging unit rotatably attached to the housing. The housing defines a receiving space at a first end thereof. Two slots are defined at a first main surface of the housing, the slots being in communication with the receiving space. The charging unit comprises a rotating member, and a pair of parallel conductive pins extending outwardly from the rotating member. The charging unit is rotatably received in the receiving space of the housing.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of a digital camera in accordance with the present invention;

FIG. 2 is another isometric view of the digital camera of FIG. 1, viewed from another aspect;

FIG. 3 is an isometric view of a housing of the digital camera of FIG. 1;

FIG. 4 is an enlarged, isometric view of a charging unit of the digital camera of FIG. 1; and

FIG. 5 is similar to FIG. 2, but showing the charging unit rotated out from the housing of the digital camera.

### DETAILED DESCRIPTION OF THE INVENTION

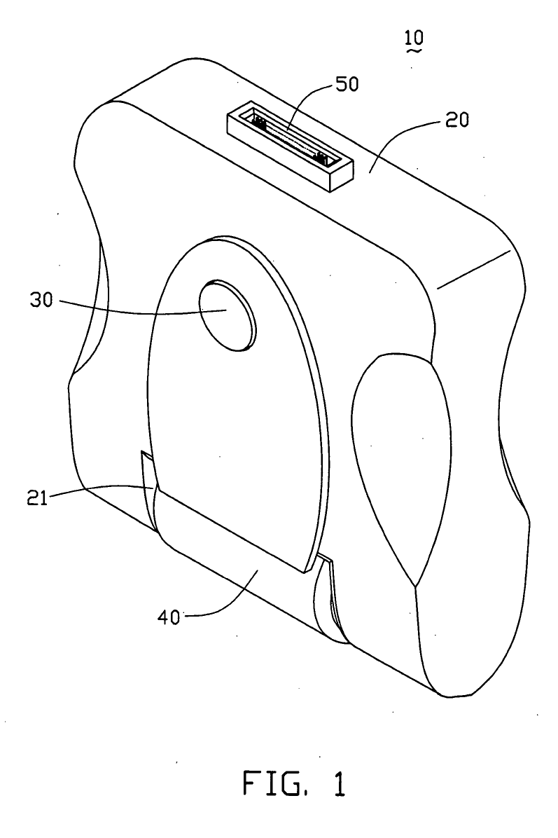

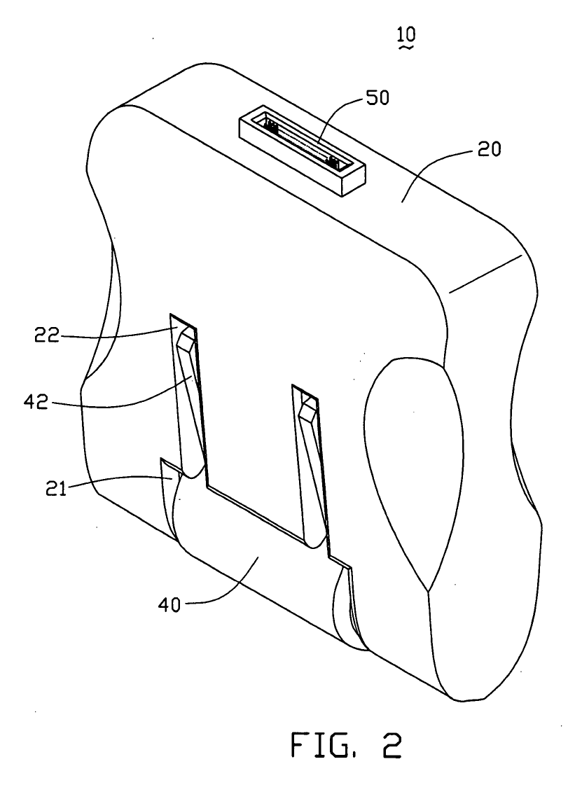

Referring to FIG. 1 and FIG. 2, a digital camera 10 in accordance with a preferred embodiment of the present invention includes a generally parallelepiped-shaped housing 20, a lens 30 and a charging unit 40. The lens 30 is disposed in the housing 20, and the charging unit 40 is rotatably attached to the housing 20.

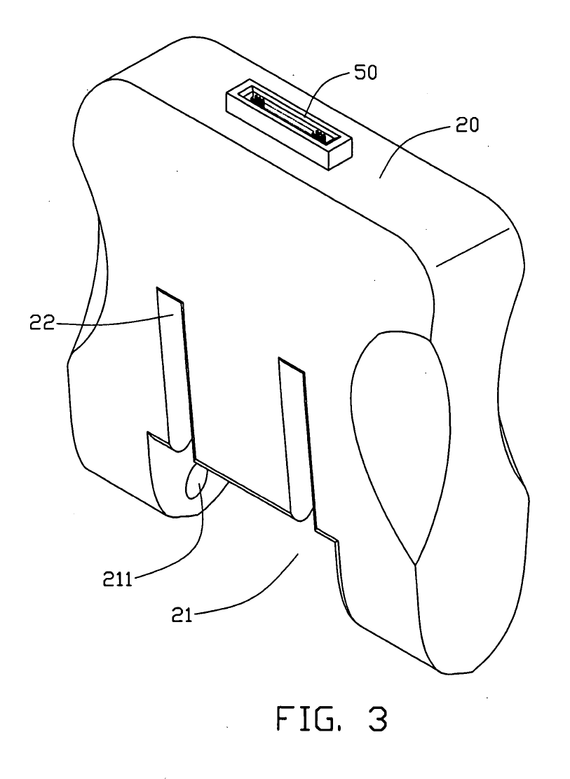

Referring also to FIG. 3, the housing 20 defines a receiving space 21 in a first end thereof for receiving the charging unit 40. Two pivot holes 211 are defined in the housing 20 at respective opposite sides of and in communication with the receiving space 21. Two parallel slots 22 are defined at a first main surface of the housing 20, the slots 22 being in communication with the receiving space 21. The housing 20 further includes a connector 50 disposed at a top portion thereof. The connector 50 is used to connect the digital camera 10 with a portable electronic device such as a mobile phone (not shown), so that an operator can use the mobile phone to control the digital camera 10.

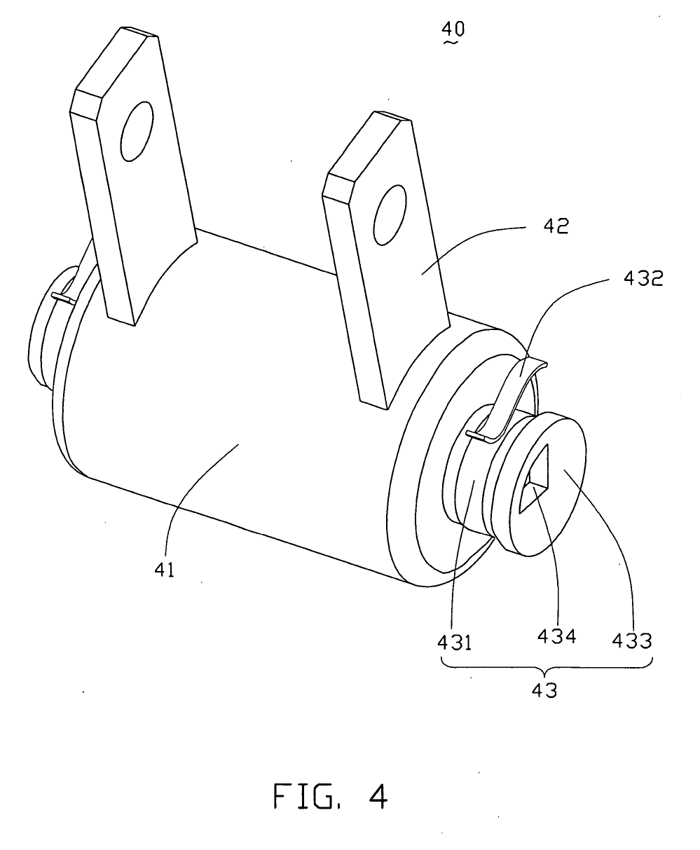

Referring also to FIG. 4, the charging unit 40 includes a cylindrical rotating member 41, two parallel pins 42 extending outwardly from a circumferential surface of the rotating member 41, and two pivots 43 disposed at opposite sides of the rotating member 41 respectively. The pins 42 are made of conductive material. Two conductive rings 431 encircle the pivots 43 respectively, and are electrically connected with the pins 42. The charging unit further includes two conductive contacts 432 for engaging with the conductive rings 431, respectively. A first end of each conductive contact 432 is fixed on a circumferential surface of the corresponding conductive ring 431, and a second end of the conductive contact 432 extends upwardly. An enlarged portion 433 is formed at a free end of each pivot 43, and the enlarged portion 433 is used to engage with a corresponding clasp structure (not shown) in the housing 20 for securely mounting the charging unit 40 on the housing 20. Two sector-shaped positioning cutouts 434 are defined in opposite distalmost side surfaces of the pivots 43, respectively. Each of the positioning cutouts 434 is used to engage with a corresponding engaging structure (not shown) in the housing 20, thus controlling rotation of the charging unit 40 within a predetermined range of angles with respect to the housing 20.

In assembly, the rotating member 41 of the charging unit 40 is rotatably received in the receiving space 21 of the housing 20, with the pivots 43 of the rotating member 41 being rotatably received in the pivot holes 211 of the housing 20 respectively. The pins 42 are respectively received in the slots 22, which are in communication with the receiving space 21.

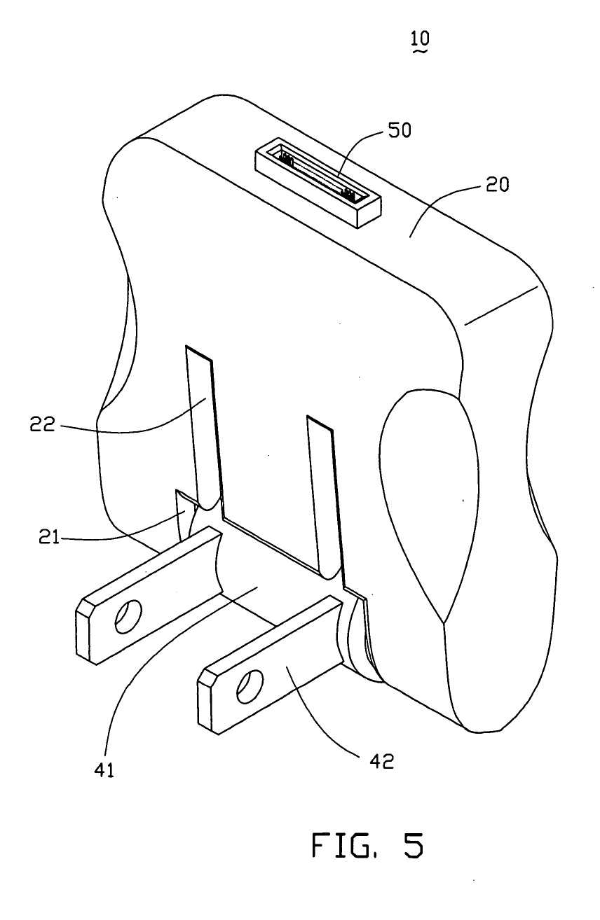

Referring also to FIG. 5, in use, the pins 42 of the charging unit 40 are rotated outwardly from the slots 22 to a predetermined angle, and the conductive contacts 432 are thus electrically connected with a voltage transformer (not shown), a voltage stabilizer (not shown) and a storage battery (not shown) disposed inside the housing 20. The pins 42 of the charging unit 40 are inserted into a receptacle of a power source (not shown), and the storage battery is thus charged via the pins 42, the conductive rings 431 and the conductive contacts 432. After the storage battery is fully charged, the pins 42 are disengaged from the receptacle and rotated back to be received in the slots 22.

It is to be understood that the charging unit 40 is not limited to being rotatably mounted to the housing 20. The charging unit 40 can alternatively be fixedly mounted in the housing 20, with the pins 42 of the charging unit 40 being slidably extended out from and slidably received back in the housing 20.

It is to be further understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. A digital camera for use with a portable electronic device, comprising:
a housing defining a receiving space at a first end thereof and a pair of slots at a main surface thereof, the slots being in communication with the receiving space;
a lens disposed in the housing; and
a charging unit rotatably received in the receiving space, the charging unit comprising a rotating member and a pair of conductive pins extending out from the rotating member.

2. The digital camera as described in claim 1, wherein the housing defines two pivot holes at opposite sides of the receiving space, respectively.

3. The digital camera as described in claim 2, wherein two pivots are disposed at opposite sides of the rotating member, respectively.

4. The digital camera as described in claim 3, wherein the pivots of the rotating member are rotatably received in the pivot holes of the housing, respectively.

5. The digital camera as described in claim 4, wherein a conductive ring is mounted on one of the pivots, and the conductive ring is electrically connected with at least one of the pins.

6. The digital camera as described in claim 5, wherein the charging unit further comprises a conductive contact connected with the conductive ring.

7. The digital camera as described in claim 4, wherein an enlarged portion is formed at a free end of at least one of the pivots of the charging unit.

8. The digital camera as described in claim 7, wherein the enlarged portion defines a positioning cutout at a side surface thereof.

9. The digital camera as described in claim 8, wherein the positioning cutout is generally sector-shaped.

10. The digital camera as described in claim 1 further comprising a connector disposed at a second end of the housing.

11. The digital camera as described in claim 1 further comprising a battery received in the housing.

12. A digital camera for use with a mobile phone, comprising:
a housing defining a receiving space;
a connector disposed at a first end of the housing and extending out from the housing;
a lens disposed in the housing; and
a charging unit received in the receiving space, the charging unit comprising a pair of conductive pins;
wherein the pins are extended out from the housing at a first position for charging of the digital camera, and the pins are received in the housing at a second position for compactness of the digital camera.

13. The digital camera as described in claim 12, wherein the pins are extended and received by way of rotation of the charging unit relative to the housing.

14. The digital camera as described in claim 12, wherein the pins are extended and received by way of sliding relative to the housing.

15. A plug-in digital camera for use with a portable electronic device, comprising:
a housing defining a receiving space;
a lens disposed in the housing;
a connector disposed on the housing and adapted to use with the portable electronic device; and
a charging unit retractably/extendably received in the receiving space, the charging unit comprising a main body with conductive pins extending out therefrom for use with an external power outlet.
